(19) United States
(12) Patent Application Publication
(10) Pub. No.: US 2008/0234440 A1
(43) Pub. Date: Sep. 25, 2008

(54) High-Performance Poly(Aryl Ether Sulfone) Composition

(75) Inventors: Douglas Brademeyer, Cumming, GA (US); Mohammad Jamal El-Hibri, Atlanta, GA (US)

Correspondence Address: Solvay Advanced Polymers, LLC;c/o Kim Manson, Esq., 4500 McGinnis Ferry Road, Alpharetta, GA, 30005-3914, US

(73) Assignee: Solvay Advanced Ploymers, L.L.C., Alpharetta, GA (US)

(21) Appl. No.: 12/089,372

(22) PCT Filed: Oct. 5, 2006
(86) PCT No.: PCT/EP06/67079

§ 371 Date: Apr. 4, 2008

Related U.S. Application Data
(60) Provisional application No. 60/723,933, filed on Oct. 6, 2005.

(51) Int. Cl. C08L 67/00

(52) U.S. Cl. 525/418

(57) ABSTRACT

Polymer composition (C) containing
a poly(aryl ether sulfone) material (P), composed of
   at least one poly(aryl ether sulfone) (P1) with a multiple benzenic ring structure, or
   at least one poly(aryl ethel sulfone) (P1) with a multiple benzenic ring structure and at least one poly(aryl ether sulfone) (P2) different from poly(aryl ether sulfone) (P1), and
a semi-aromatic polyester material (P*), composed of
   at least one semi-aromatic polyester (P1*) with a multiple benzenic ring structure, or
   at least one semi-aromatic polyester (P1*) with a multiple benzenic ring structure and at least one semi-aromatic polyester (P2*) different from semi-aromatic polyester (P1*),
      wherein the semi-aromatic polyester material (P*) over poly(aryl ether sulfone) material (P) weight ratio [(P*)/(P) weight ratio] is between 0.13 and 1.00.

### CROSS-REFERENCE TO RELATED APPLICATIONS

The present application claims the benefit of U.S. application Ser. No. 60/723,933 filed Oct. 6, 2005, the whole content of which is incorporated herein by reference.

The present invention relates to a high-performance poly(aryl ether sulfone) composition, which is in general especially well suited notably for hydrodynamic fluid bearing applications.

Poly(aryl ether sulfone)s, including the commercially available polysulfones, poly(ether sulfone)s, poly(ether ether sulfone)s and poly(biphenyl ether sulfone)s, are among the most performing amorphous engineering polymers. They have been valued for years because of their excellent thermal stability, along with their high tensile strength, outstanding toughness, high dimensional stability, high heat deflection temperature, inherent flame retardancy (combustion resistance without additives), and fairly good environmental stress cracking resistance. As a result thereof, poly(aryl ether sulfone)s have found application in numerous severe applications including electrical and electronic components such as connectors, sockets and trays, aircraft components such as interior panels and bags, pipe fittings and manifolds for plastic piping systems, and even friction-and-wear resistant components such as bushings, thrust washers, bearings, slides and gears.

The problem is that, in some applications, especially in friction and-wear-resistant components, the poly(arly ether sulfone) component is possibly contacted, under stress, with so aggressive environments (including aromatics, ketones and chlorinated hydrocarbons) that the yet intrinsically fairly good environmental stress cracking resistance of the poly(aryl ether sulfone) is far from being sufficient to prevent the component from cracking. The problem is especially acute in fluid dynamic bearing applications for hard disk drive components, where a poly(aryl ether sulfone) bearing is under high stress and in permanent contact with an aggressive lubricant, typically an oil diester; under these circumstances, the poly(aryl ether sulfone) is not capable of surviving the diester lubricant environment.

There is thus a need for providing a composition of matter with improved environmental stress cracking resistance, especially against esters and very especially against oil diester lubricants, when compared to prior art poly(aryl ether sulfone) compositions, while maintaining all the beneficial properties of the prior art poly(aryl ether sulfone) compositions at a very high level. Such composition of matter should be advantageously especially well suited for making the fluid dynamic bearing as above described.

Since they exhibit notably limited thermal performance, semi-aromatic polyesters like poly(ethylene terephthalate)s, poly(butylene terephthalate)s and poly(ethylene naphthalate)s, are unsuitable for bearing applications. On the other hand, semi-aromatic polyesters have found extensive application in rigid and flexible packaging, notably because of their good moisture and gas barrier.

U.S. Pat. No. 3,742,087 (assigned to Imperial Chemical Industries Limited) describes blends comprising in general from 99.9 to 1 percent of one or more poly(aryl ether sulfone)s with 0.1 to 99 percent of one or more polyesters. According to U.S. Pat. No. 3,742,087, as it were, any poly(aryl ether sulfone) and any polyester would be suitable to be blended so as to provide blends with a satisfactory compromise between melt processability and mechanical properties, especially impact strength. Thus, per U.S. Pat. No. 3,742,087, poly(aryl ether sulfone)s with single benzenic rings like polysulfones and poly(ether sulfone)s on one hand, and poly(ether ether sulfone)s with multiple rings such as poly(phenyl ether sulfone)s on the other hand, would be indifferently suitable. Similarly, per U.S. Pat. No. 3,742,087, polyesters with no benzenic ring such as as poly(ethylene sebacate)s, polyesters with a single benzenic ring such as poly(ethylene terephthalate)s and polyesters with multiple benzenic rings such as poly(ethylene naphthalate)s would be indifferently suitable. Among all these blends, those containing no more than 5 percent of polyester would be of particular interest in that mechanical properties of the poly(aryl ether sulfone) would be largely retained while significant properties of melt flow would be obtained (see col. 4, 1. 5-10). U.S. Pat. No. 3,742,087 keeps silent about the benefits that might result from combining, in a specific weight ratio, a poly(aryl ether sulfone) of a very specific type, namely a poly(aryl ether sulfone) with multiple benzenic rings, with a polyester a very specific type, namely a semi-aromatic polyester with multiple benzenic rings, and, among the numerous exemplified blends, none corresponds to this combination. In addition, U.S. Pat. No. 3,742,087 does not address the problem of environmental stress cracking resistance of poly(aryl ether sulfone)s; nor does it teach that poly(aryl ether sulfone)—polyester blends might be suitable for fluid dynamic bearing applications.

Yet, at least part of, and preferably all the desired requirements for a composition of matter be used notably in a fluid dynamic bearing application, in particular providing an excellent environmental stress cracking resistance with regard to lubricants like oil diesters, while achieving an extremely high level of mechanical properties, and possibly still other additional requirements, are met by a polymer composition (C) containing
a poly(aryl ether sulfone) material (P), composed of
   at least one poly(aryl ether sulfone) (P1) with a multiple benzenic ring structure, or
   at least one poly(aryl ether sulfone) (P1) with a multiple benzenic ring structure and at least one poly(aryl ether sulfone) (P2) different from poly(aryl ether sulfone) (P1), and
a semi-aromatic polyester material (P*) composed of
   at least one semi-aromatic polyester (P1*) with a multiple benzenic ring structure, or
   at least one semi-aromatic polyester (P1*) with a multiple benzenic ring structure and at least one semi-aromatic polyester (P2*) different from semi-aromatic polyester (P1*),
      wherein the semi-aromatic polyester material (P*) over poly(aryl ether sulfone) material (P) weight ratio [(P*)/(P) weight ratio] is between 0.13 and 1.00.

The (P*)/(P) weight ratio is preferably above 0.20 and more preferably above 0.30. Besides, it is preferably below 0.90, more preferably below 0.70 and still more preferably below 0.50.

The combined weight amount of poly(aryl ether sulfone) material (P) and semi-aromatic polyester material (P*) [(P)+(P*) weight amount] is advantageously more than 10 wt. %, preferably more than 20 wt. %, more preferably more than 40 wt. % and still more preferably more than 50 wt. %, based on the total weight of polymer composition (C).

For certain end uses [end uses (E)], good results were obtained when the combined weight amount (P)+(P*) did not exceed 90 wt. %, or, still better, when it did not exceed 80 wt. %, based on the total weight of polymer composition (C).

For certain other end uses, good results were obtained when the combined weight amount (P)+(P*) exceeded 90 wt. %, or still better, when it was of at least 95 wt. %, based on the total weight of polymer composition (C).

The poly(aryl ether sulfone) material. As previously mentioned, polymer composition (C) contains a poly(aryl ether sulfone) material (P). For the purpose of the invention, a poly(aryl ether sulfone) material is intended to denote one or more polycondensation polymer(s) of which more than 50 mol. % of the recurring units contain at least one ether group (—O—), at least one sulfone group (—SO₂—) and at least one arylene group (G).

Poly(aryl ether sulfone) material (P) is contained in polymer composition (C) in an amount of advantageously more than 10 wt. %, preferably more than 25 wt. %, and more preferably more than 40 wt. %, based on the total weight of polymer composition (C). Besides, poly(aryl ether sulfone) material (P) is contained in polymer composition (C) in an amount of advantageously less than 95 wt. %, preferably less than 90 wt. %, and more preferably less than 85 wt. %, based on the total weight of polymer composition (C).

Still more preferred amounts can be defined; these ones depend notably upon the encompassed end-use.

For certain end uses [end uses (E)], good results were obtained when poly(aryl ether sulfone) material (P) was contained in polymer composition (C) in an amount not exceeding 60 wt. %.

For certain other end uses, good results were obtained when poly(aryl ether sulfone) material (P) was contained in polymer composition (C) in an amount exceeding 60 wt. %.

Poly(aryl ether sulfone) material (P) contains at least one poly(aryl ether sulfone) with a multiple benzenic ring structure, hereafter poly(aryl ether sulfone) (P1).

For the purpose of the invention, a poly(aryl ether sulfone) with a multiple benzenic ring structure is intended to denote a polycondensation polymer of which more than 50 mol. % of the recurring units are recurring units (R1), wherein recurring units (R1) are those containing at least one ether group (—O—), at least one sulfone group (—SO₂—), and at least one arylene group (G) comprising at least two benzenic rings, each of them:
having at least 2 carbon atoms in common with at least one other benzenic ring of the same arylene group (the benzenic rings are fused),
   and/or
being joined directly by at least one single bond to at least one other benzenic ring of the same arylene group.

Non limitative examples of arylene groups (G) with fused benzenic rings are naphthylenes (such as 2,6-naphthylene), anthrylenes (such as 2,6-anthrylene) and phenanthrylenes (such as 2,7-phenanthrylene), naphthacenylenes and pyrenylenes groups.

Non limitative examples of arylene groups (G) with directly joined benzenic rings are biphenylene groups such as p-biphenylene, triphenylene groups such as p-triphenylene and tetramethylene groups such as p-tetraphenylene.

Non limitative examples of arylene groups (G) with fused and directly joined benzenic rings are binaphthylenes.

Recurring units (R1) are preferably those containing at least one ether group (—O—), at least one sulfone group (—SO₂—) and at least one p-biphenylene group:

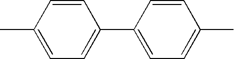

Recurring units (R1) are more preferably:

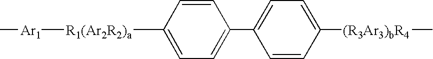

wherein R₁ through R₄ are —O—, —SO₂—, —S—, —CO—, with the proviso that at least one of R₁ through R₄ is —SO₂— and at least one of R₁ through R₄ is —O—; Ar₁, Ar₂ and Ar₃ are arylene groups containing from 6 to 24 carbon atoms, and are preferably phenylene or p-biphenylene; and a and b are either 0 or 1.

Recurring units (R1) are still more preferably

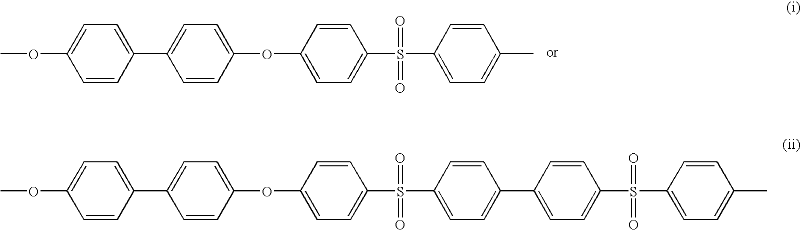

or (iii) a mixture consisting of more than 50 mol. %, based on the mixture, of recurring units:

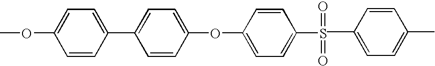

with less than 50 mol. %, based on the mixture, of one or more of the following recurring units:

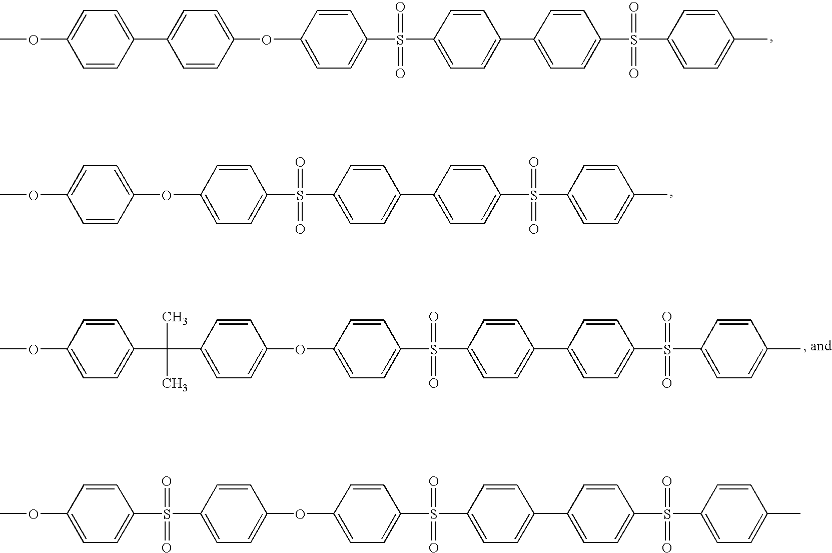

or (iv) a mixture consisting of more than 50 mol. %, based on the mixture, of recurring units

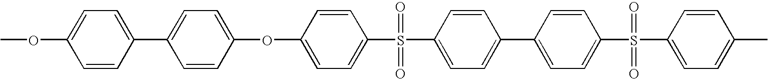

with less than 50 mol. %, based on the mixture, of one or more of the following recurring units:

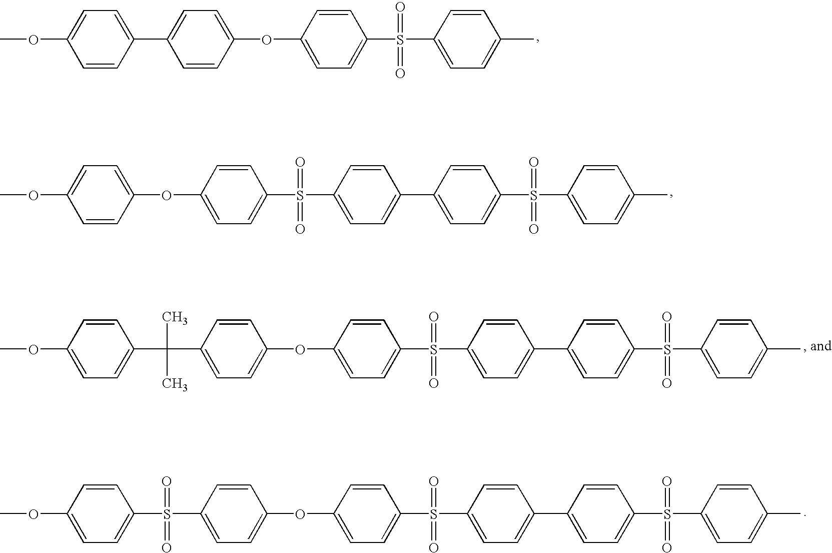

The most preferably, recurring units (R1) are:

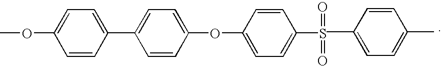

The corresponding poly(aryl ether sulfone) is commonly referred to as poly(biphenyl ether sulfone).

Optionally, poly(aryl ether sulfone) (P1) may further comprise recurring units (R2) different from recurring units (R1).

Recurring units (R2) are preferably chosen from:

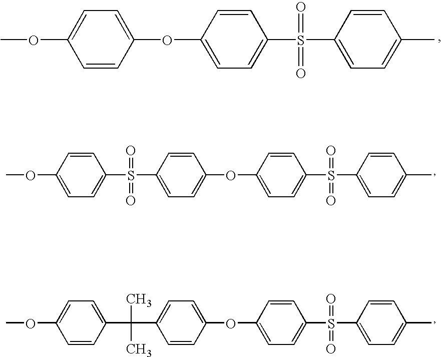

and mixtures thereof.

Poly(aryl ether sulfone) (P1) may notably be a homopolymer, a random, alternating or block copolymer.

Preferably at least 70 wt. %, and more preferably at least 85 wt. % of the recurring units of poly(aryl ether sulfone) (P1) are recurring units (R1). Still more preferably, poly(aryl ether sulfone) (P1) is a homopolymer: all its recurring units are recurring units (R1). Excellent results were obtained with homopolymers the recurring units of which are:

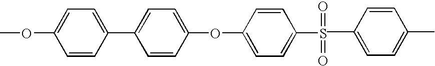

Commercial RADEL® R polyphenylsulfone grades from Solvay Advanced Polymers, L.L.C. are examples of the above homopolymer.

As previously mentioned, poly(aryl ether sulfone) material (P) may contain, in addition to poly(aryl ether sulfone) (P1), at least one poly(aryl ether sulfone) (P2) different from poly(aryl ether sulfone) (P1).

Poly(aryl ether sulfone) (P2) can be advantageously chosen from polysulfones, polyethersulfones and polyetherethersulfones.

Polyetherethersulfones, as herein defined, are polycondensation polymers of which more than 50 mol. % of the recurring units are:

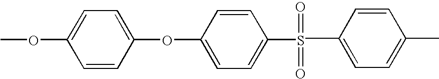

Polyethersulfones, as herein defined, are polycondensation polymers of which more than 50 mol. % of the recurring units are:

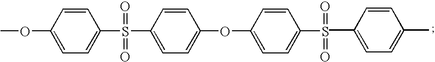

said polyethersulfones may optionally further comprise notably less than 50 mol. % of recurring units

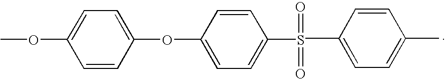

Polyethersulfones are commercially available as RADEL® A from Solvay Advanced Polymers, L.L.C.

Polysulfones, as herein defined, are polycondensation polymers of which more than 50 mol. % of the recurring units are:

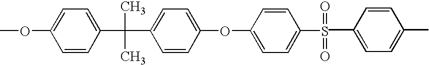

Polysulfones are commercially available as UDEL® PSF from Solvay Advanced Polymers, L.L.C.

Poly(aryl ether sulfone) (P2) is preferably chosen from polyethersulfones and polyetherethersulfones, and more preferably from polyethersulfones.

Generally:
it is preferred that the weight of poly(aryl ether sulfone) (P2) be less than ⅓ of the weight of poly(aryl ether sulfone) material (P);
it is more preferred the weight of poly(aryl ether sulfone) (P2) be less than ⅕ of the weight of poly(aryl ether sulfone) material (P);
it is still more preferred that the weight of poly(aryl ether sulfone) (P2) be less than 1/10 of the weight of poly(aryl ether sulfone) material (P); and
its most preferred that poly(aryl ether sulfone) material (P) be free of poly(aryl ether sulfone) (P2); otherwise said, it is most preferred that poly(aryl ether sulfone) material (P) be composed of poly(aryl ether sulfone) (P1).

Limiting the amount of poly(aryl ether sulfone) (P2) in poly(aryl ether sulfone) material (P) results usually in an improved balance of properties.

However, in some instances, especially when there is a need to lower the cost of polymer composition (C) while maintaining a fairly high level of properties, it is preferred that the weight of poly(aryl ether sulfone) (P2) ranges from ⅓ to ⅔ of the weight of poly(aryl ether sulfone) material (P).

Poly(aryl ether sulfone)s (P1) and (P2) are advantageously amorphous.

The semi-aromatic polyester material. As previously mentioned, polymer composition (C) contains a semi-aromatic polyester material (P*).

For the purpose of the invention, a semi-aromatic polyester material is intended to denote one or more polycondensation polymer(s) of which more than 50 mol. % of the recurring units contain at least one ester group [—C(═O)O—], at least one alkylene group, and at least one arylene group (G*).

Semi-aromatic polyester material (P*) is contained in polymer composition (C) in an amount of advantageously more than 3.0 wt. %, preferably more than 6.0 wt. %, and more preferably more than 12 wt. %, based on the total weight of polymer composition (C). Besides, semi-aromatic polyester material (P*) is contained in polymer composition (C) in an amount of advantageously less than 45 wt. %, preferably less than 40 wt. %, and more preferably less than 35 wt. %, based on the total weight of polymer composition (C).

Still more preferred amounts can be defined; these ones depend notably upon the encompassed end-use.

For certain end uses [notably for end uses (E)], good results were obtained when semi-aromatic polyester material (P*) was contained in polymer composition (C) in an amount not exceeding 25 wt. %.

For certain other end uses, good results were obtained when semi-aromatic polyester material (P*) was contained in polymer composition (C) in an amount exceeding 25 wt. %.

Semi-aromatic polyester material (P*) contains at least one semi-aromatic polyester with a multiple benzenic ring structure, hereafter semi-aromatic polyester (P1*).

For the purpose of the invention, a semi-aromatic polyester with a multiple benzenic ring structure is intended to denote a polycondensation polymer of which more than 50 mol. % of the recurring units are recurring units (R1*), wherein recurring units (R1*) are those containing at least one ester group, at least one alkylene group, and at least one arylene group (G*) comprising at least two benzenic rings, each of them:
having at least 2 carbon atoms in common with at least one other benzenic ring of the same arylene group (the benzenic rings are fused),
   and/or
being joined directly by at least one single bond to at least one other benzenic ring of the same arylene group.

As non limitative examples of arylene groups (G*) with fused and/or directly joined benzenic rings, we can cite the same arylene groups as those previously cited as non limitative examples of arylene groups (G), respectively with fused and/or directly joined benzenic rings.

Preferred recurring units (R1*) consist of one or tho ester group(s), one C₂-C₈ alkylene group, and one arylene group (G*), wherein the ester group(s) is (are) directly joined to arylene group (G3*) by one single bond; said preferred recurring units (R1*) are:

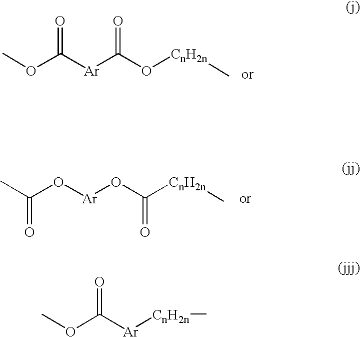

or mixtures thereof,
wherein:
recurring units (j) and (jj) are preferred over recurring units (jjj), and recurring units (j) are preferred over recurring units (jj);
CₙH₂ₙ is the C₂-C₈ alkylene group, preferably a linear C₂-C₈ alkylene group, more preferably a linear C₂, C₃ or C₄ alkylene group, and
Ar is arylene group (G*), preferably a naphthylene group, and still more preferably a 2,6-naphthylene group, namely

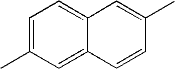

Recurring units (R1*) are still more preferably:

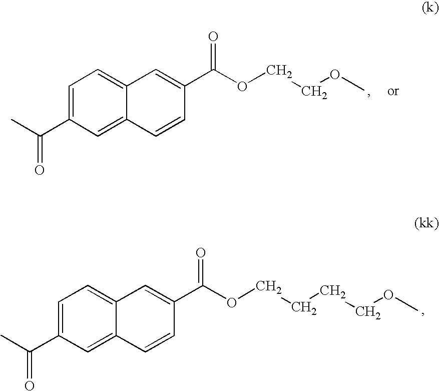

or (kkk) a mixture consisting of (k) and (kk).

The most preferable recurring units (R1*) are:

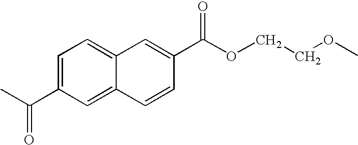

The corresponding semi-aromatic polyesters are commonly referred to as poly(ethylene naphthalate)s.

Optionally, semi-aromatic polyester (P1*) may further comprise recurring units (R2*) different from recurring units (R1*).

Recurring units (R2*) are advantageously chosen from:

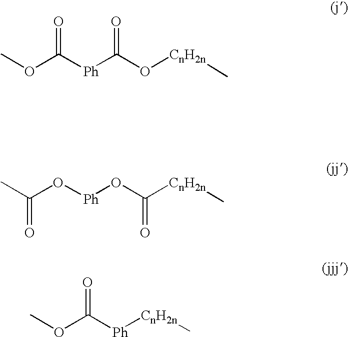

and mixtures thereof,
wherein:
recurring units (j′) and (jj″) are preferred over recurring units (jjj′), and recurring units (j′) are preferred over recurring units (jj′);
CₙH₂ₙ is a C₂-C₈ alkylene group, preferably a linear C₂-C₈ alkylene group, more preferably a linear C₂, C₃ or C₄ alkylene group, and
Ph is phenylene group, preferably a p-phenylene group.

Recurring units (R2*) are preferably chosen from:

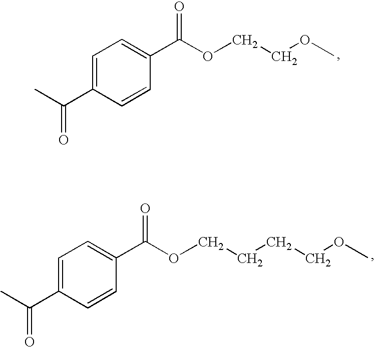

and mixtures thereof.

Semi-aromatic polyester (P1*) may notably be a homopolymer, a random, alternating or block copolymer. Preferably at least 70 wt. %, and more preferably at least 85 wt. % of the recurring units of semi-aromatic polyester (P1*) are recurring units (R1*). Still more preferably, semi-aromatic polyester (P1*) is a homopolymer of recurring units (R1*). Excellent results were obtained with homopolymers the recurring units of which are:

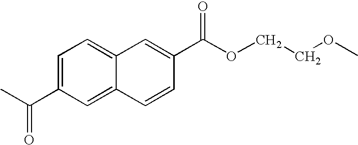

TEONEX® polyethylenenaphthalate from Teijin Chemicals is an example of the above homopolymer.

As previously mentioned, semi-aromatic polyester material (P*) may contain, in addition to semi-aromatic polyester (P1*), at least one semi-aromatic polyester (P2*) different from semi-aromatic polyester (P1*).

Semi-aromatic polyester (P2*) is advantageously a polycondensation polymer of which more than 50 mol. % of the recurring units are chosen from

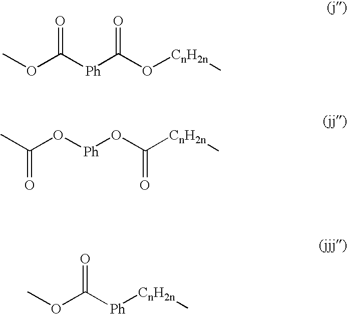

and mixtures thereof,
wherein:
recurring units (j″) and (jj″) are preferred over recurring units (jjj″), and recurring units (j″) are preferred over recurring units (jj″);
CₙH₂ₙ is a C₂-C₈ alkylene group, preferably a linear C₂-C₈ alkylene group, more preferably a linear C₂, C₃ or C₄ alkylene group, and
Ph is phenylene group, preferably a p-phenylene group.

Semi-aromatic polyester (P2*) is preferably chosen from polyethyleneterephthalates and polybutyleneterephthalates.

Polyethylenieterephthalates, as herein defined, are polycondensation polymers of which more than 50 mol. % of the recurring units are:

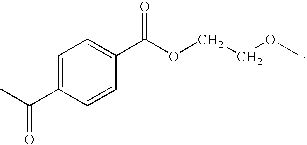

Polybutyleneterephthalates, as herein defined, are polycondensation polymers of which more than 50 mol. % of the recurring units are:

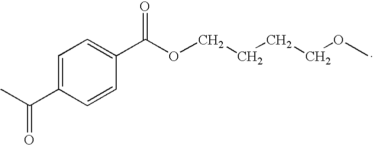

Semi-aromatic polyester (P2*) is more preferably chosen from polyethyleneterephthalates, preferably from polyethyleneterephthalates homopolymers and polyethyleneterephthalates copolymers the recurring units of which consist of, on one hand:

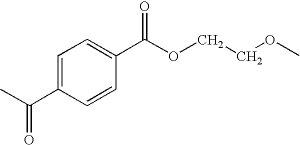

and, on the other hand, either

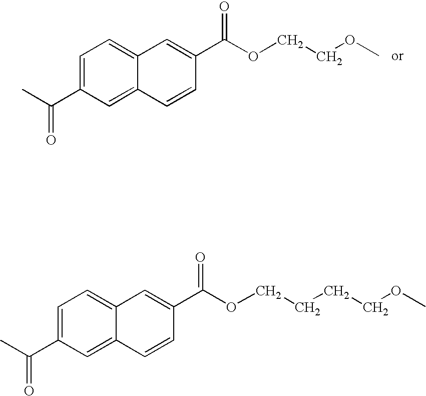

or a mixture of the above two recurring units.

Generally:
it is preferred that the weight of semi-aromatic polyester (P2*) be less than ⅓ of the weight of semi-aromatic polyester material (P*);
it is more preferred the weight of semi-aromatic polyester (P2*) be less than ⅕ of the weight of semi-aromatic polyester material (P*);
it is still more preferred that the weight of semi-aromatic polyester (P2*) be less than 1/10 of the weight of semi-aromatic polyester material (P*); and
it is most preferred that semi-aromatic polyester material (P*) be free of semi-aromatic polyester (P2*); otherwise said, it is most preferred that semi-aromatic polyester material (P*) be composed of semi-aromatic polyester (P1*).

Limiting the amount of semi-aromatic polyester (P2*) in semi-aromatic polyester material (P*) results usually in an improved balance of properties.

Semi-aromatic polyesters (P1*) and (P2*) are advantageously semi-crystalline.

Polymer composition (C) may further comprise other ingredients suitable for being used in poly(aryl ether sulfone) compositions, notably:
inorganic flame retardants like zinc borate,
inorganic heat stabilizers like zinc oxide,
pigments like titanium dioxide and carbon black,
reinforcing fibrous fillers like glass fiber, graphite fiber, silicon carbide fiber,
reinforcing particulate fillers like particles consisting of a metal or of a metal alloy,
nucleating agents such as talc and mica,
mold release agents like flurorocarbon polymers, and polymers other than poly(aryl ether sulfone)s and semi-aromatic polyesters, like poly(ether imide)s.

It is sometimes preferred that polymer composition (C) further comprises at least one reinforcing particulate filler, more preferably a metal or a metal alloy in particulate form, still more preferably stainless steel in particulate form. The case being, the amount of the reinforcing particulate filler ranges advantageously between 1.0 and 50 wt. %; it is preferably above 5.0 and more preferably above 10 wt. %; besides, it is preferably below 40 and more preferably below 30 wt. % [all percentages being based on the total weight of polymer composition (C)].

It is also sometimes preferred that polymer composition (C) further comprises at least one reinforcing fibrous filler, more preferably graphite fiber. The case being, the amount of the reinforcing fibrous filler ranges advantageously between 1.0 and 50 wt. %; it is preferably above 2.0 wt. %; besides, it is preferably below 20 wt. % [all percentages being based on the total weight of polymer composition (C)].

It is also sometimes preferred that polymer composition (C) further comprises at least one mold release agent; the case being, the amount of the mold release agent ranges advantageously between 0.2 and 20 wt. %; it is preferably above 1.0 wt. %; besides, it is preferably below 10 wt. % [all percentages being based on the total weight of polymer composition (C)]. The mold release agent is preferably a fluorocarbon polymer, more preferably a polytetrafluoroethylene (PTFE), still more preferably a non fibrillating PTFE. For the purpose of the present invention, a fluorocarbon polymer is intended to denote any polymer of which more than 50 mol. % of the recurring units are derived from at least one ethylenically unsaturated monomer comprising at least one fluorine atom. For the purpose of the present invention, a PTFE is intended to denote any polymer of which more than 50 mol. % of the recurring units are derived from tetrafluoroethylene.

Non fibrillating PTFE are also commonly referred to as “low molecular weight PTFE” or “low melt viscosity PTFE”. They are generally homopolymers. They have generally a number-average molecular weight of between 50,000 and 700,000 (as determined by conventional GPC technique). They are generally obtained by irradiation degradation of a high molecular weight PTFB (typically, with a number-average molecular weight above 2,000,000), or directly by polymerization technique such as disclosed in example 1 of U.S. Pat. No. 5,223,343. They are generally in the form of finely divided solids (average particle size of less than 20 μm), and are then also commonly referred to as “PTFE micropowders”. Non fibrillating PTFE are commercially available notably from Solvay Solexis, Inc. as POLYMIST® PTFE.

The additional presence of a reinforcing particulate filler and/or a reinforcing fibrous filler and/or a mold release agent is preferred notably when the invented composition is to be used in end uses (E).

Besides, it is sometimes preferred that polymer composition (C) further comprises at least one poly(ether imide); the case being, the amount of the poly(ether imide) ranges advantageously between 1.0 and 50 wt. %; it is preferably above 2.0 wt. %; besides, it is preferably below 20 wt. % [all percentages being based on the total weight of polymer composition (C)]. For the purpose of the invention, a poly(ether imide) is intended to denote any polymer of which more than 50 wt. % of the recurring units are recurring units (R3) comprising two imide groups as such [(R3-A) groups] and/or in their corresponding amic acid forms [(R3-B) and (R3-C) groups];

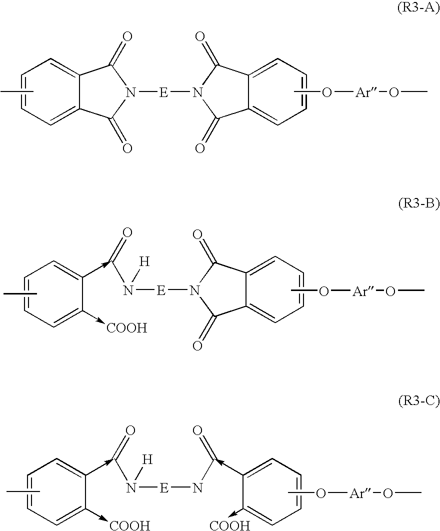

wherein:
the → denotes isomerism so that in any recurring unit the groups to which the arrows point may exist as shown or in an interchanged position;
E is typically:

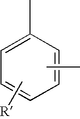

with R′ being a hydrogen atom or an alkyl radical comprising from 1 to 6 carbon atoms;

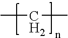

with n=integer from 1 to 6;

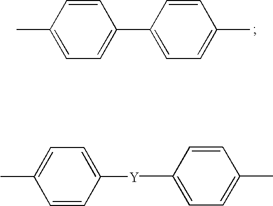

with Y being:

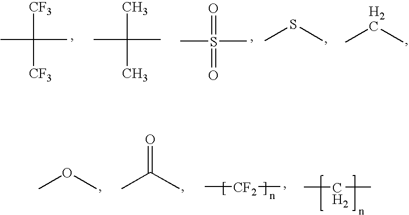

with n integer from 1 to 6;
Ar″ is typically:

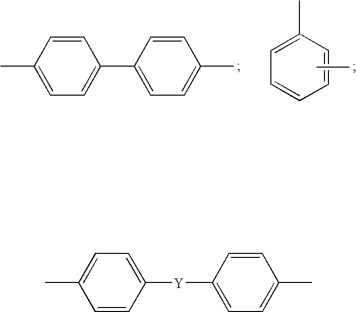

with Y being:

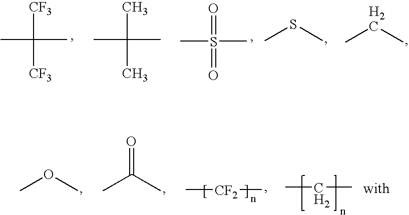

n=integer from 1 to 6.

Recurring units (R3) are preferably
recurring units (1), in imide form (1-A) and/or in amic acid forms [(1-B) and (1-C)]:

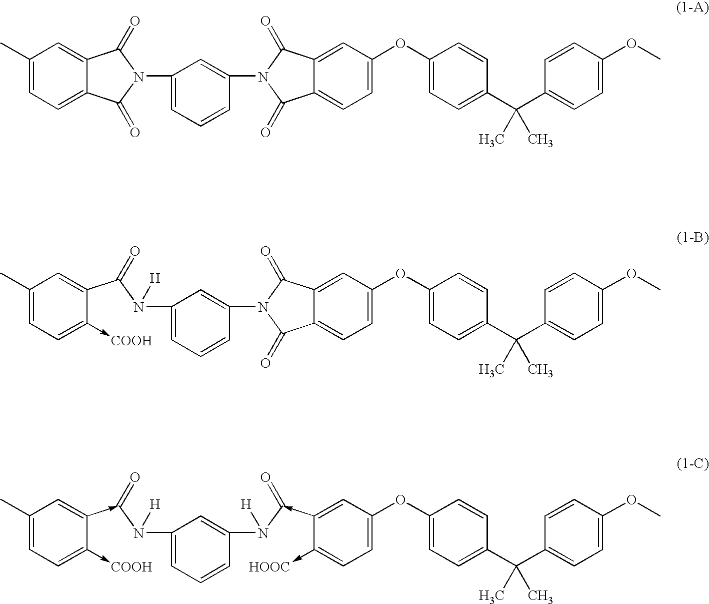

wherein in formulae (1-B) and (1-C) the → denotes isomerism so that in any recurring unit the groups to which the arrows point may exist as shown or in an interchanged position;
and/or
recurring units (1′), in imide form (1-A) and/or in amic acid forms [(1′-B) and (1′-C)], wherein recurring units (1′), (1′-A), (1′-B) and (1′-C) are identical to respectively recurring units (1), (1-A), (1-B) and (1-C), except that the two amino groups are linked to a p-phenylene group instead of the m-phenylene group of recurring units (1), (1-A), (1-B) and (1-C).

It has been surprisingly found that, in certain invented compositions, the poly(ether imide) improved the dispersion of the poly(aryl ether sulfone) material (P) and of the semi-aromatic polyester material (P*) in polymer composition (C), resulting in an improved homogeneity of said composition. It has also been surprisingly found that, in certain invented polymer compositions, the poly(ether imide) was helpful to reduce the degree of crystallinity of polymer composition (C). Finally, it has been surprisingly found that, in certain invented polymer compositions, the poly(ether imide) improved the mechanical properties.

It is also sometimes preferred that polymer composition (C) be essentially flee of filler, and, more preferably, be essentially composed of poly(aryl ether sulfone) material (P), of semi-aromatic polyester material (P*) and, optionally in addition, of poly(ether imide).

Polymer composition (C) is advantageously prepared by any conventional mixing method. A preferred method comprises dry mixing the ingredients of polymer composition (C) in powder or granular form, using e.g. a mechanical blender, then extruding the mixture into strands and chopping the strands into pellets.

Another aspect of the present invention is directed to high-performance shaped articles, with excellent environmental stress cracking resistance with regard to various chemicals, especially lubricants like oil diesters, and with an extremely high level of mechanical properties.

With this end in view, the present invention concerns a shaped article (S) comprising the polymer composition as above described.

Shaped article (S) proved to be superior with regard to prior art similar shaped articles, especially when contacted under stress with a chemically aggressive environment like a diester oil lubricant.

Shaped article (S) can be friction and wear resistant; in particular, it can be a bearing. Other friction and wear resistant articles include bushings, thrust washers, slides and gears.

Alternatively, shaped article (S) can differ from a bearing, and, more generally, from a friction and wear resistant article.

End uses (E) as above referred to include usually friction and wear resistant articles, in particular bearings.

Shaped article (S) can be notably temporarily or permanently under stress.

Shaped article (S) can be notably temporarily or permanently in contact with a chemical aggressive environment, in particular with an aromatic compound, a ketone, a chlorinated hydrocarbon or an ester; more particularly with an ester and still more particularly with a diester oil.

Still another aspect of the invention is directed to a multi-component article (A) comprising as components:
at least one shaped article (S), and
at least one organic liquid,
   said organic liquid being in contact with shaped article (S).

The organic liquid can be an aromatic compound, a ketone or an ester like diester oil.

Finally, a last aspect of the present invention is directed to the use of a semi-aromatic polyester material (P*) composed of
at least one semi-aromatic polyester (P1*) with a multiple benzenic ring structure, or
at least one semi-aromatic polyester (P1*) with a multiple benzenic ring structure and at least one semi-aromatic polyester (P2*) different from semi-aromatic polyester (P1*),
   in a weight amount [(P*)/(P)] between 0.13 and 1.00, based on the weight amount of a poly(aryl ether sulfone) material (P) composed of
at least one poly(aryl ether sulfone) (P1) with a multiple benzenic ring structure, or
at least one poly(aryl ether sulfone) (P1) with a multiple benzenic ring structure and at least one poly(aryl ether sulfone) (P2) different from poly(aryl ether sulfone) (P1),
   to improve the environmental stress cracking resistance of a polymer composition containing said poly(aryl ether sulfone) material (P).

(P*)/(P) is preferably above above 0.20 and more preferably above 0.30. Besides, it is preferably below 0.90, more preferably below 0.70 and still more preferably below 0.50.

Semi-aromatic polyester material (P*) and poly(aryl ether sulfone) material (P) involved in the presently invented use comply with all the characteristics of semi-aromatic polyester material (P*) and poly(aryl ether sulfone) material (P) contained in the invented polymer composition [polymer composition (C)], at any level of preference.

Semi-aromatic polyester material (P*) is usually blended with poly(aryl ether sulfone) material (P) and possibly other optional ingredients, so as to form a polymer composition, the content of which is identical, as to the nature of its ingredients and their amounts, to the content of the invented polymer composition [polymer composition (C)].

The environment is advantageously an aromatic compound, a ketone, a chlorinated hydrocarbon or an ester, preferably with an ester and still more preferably a diester oil.

Provided below are examples illustrative of the present invention, but not limitative thereof.

### EXAMPLES

Eight polymer compositions were prepared according to the present invention, namely polymer compositions E2, E3, E4, E5, E6, E7, E8 and EP9. A polymer composition to the contrary of the invention, namely polymer composition CE1, was also prepared for comparison. The nature and amount of all the ingredients contained in the exemplified polymer compositions are listed in table 1.

TABLE 1

| | CE1 | E2 | E3 | E4 | E5 | E6 | E7 | E8 | E9 |
|---|---|---|---|---|---|---|---|---|---|
| Ingredients | | | | | | | | | |
| RADEL ® R 5800 NT poly(biphenyl ether sulfone) | 100 | 87.5 | 80 | 75 | 75 | 55.95 | 54 | 70 | 65 |
| [Polymer (P)] | | | | | | | | | |
| TEONEX ® TN8065S poly(ethylene naphthalate) | 0 | 12.5 | 20 | 20 | 25 | 18.65 | 18 | 30 | 30 |
| [Polymer (P*)] | | | | | | | | | |
| ULTEM ® 1010 poly(ether imide) | 0 | 0 | 0 | 5 | 0 | 0 | 0 | 0 | 5 |
| Stainless steel | 0 | 0 | 0 | 0 | 0 | 19.9 | 20 | 0 | 0 |
| Carbon fiber | 0 | 0 | 0 | 0 | 0 | 5 | 5 | 0 | 0 |
| Non fibrillating PTFE | 0 | 0 | 0 | 0 | 0 | 0 | 3 | 0 | 0 |
| Zinc oxide | 0 | 0 | 0 | 0 | 0 | 0.5 | 0 | 0 | 0 |
| [(P*)/(P)] weight ratio | 0 | 0.14 | 0.25 | 0.27 | 0.33 | 0.33 | 0.33 | 0.43 | 0.46 |
| Mechanical properties | | | | | | | | | |
| Tensile strength (psi) | 10800 | — | 11800 | — | — | — | — | 11600 | 12100 |
| Tensile modulus (Ksi) | 317 | — | 339 | — | — | — | — | 335 | 350 |
| Yield elongation (%) | 7.7 | — | 7.6 | — | — | — | — | 7.7 | 7.5 |
| Tensile elongation at break (%) | 73 | — | 43 | — | — | — | — | 19 | 47 |
| Flexural strength (psi) | 14100 | — | 14800 | — | — | — | — | 14900 | 15100 |
| Flexural modulus (Ksi) | 341 | — | 344 | — | — | — | — | 359 | 352 |
| Notched Izod (ft.lb/in) | 13.0 | — | 1.8 | — | — | — | — | 1.4 | 1.4 |
| Heat deflection temp. at 264 psi (° C.) | 211 | — | 200 | — | — | — | — | 203 | 201 |
| Weld line tensile properties | | | | | | | | | |
| Tensile strength (psi) | 11000 | — | 6000 | 6100 | — | — | — | 6300 | 4800 |
| Elongation at break (%) | 27 | — | 1.9 | 2.0 | — | — | — | 1.8 | 1.4 |
| Stress cracking resistance in MEK | | | | | | | | | |
| Stress level = 1000 psi, duration = 24 h | Cracked | — | OK | OK | — | — | — | OK | OK |
| Stress level = 1500 psi, duration = 24 h | Cracked | — | Cracked | Cracked | — | — | — | OK | OK |
| Stress cracking resistance in toluene | | | | | | | | | |
| Stress level = 1500 psi, duration = 24 h | Cracked | — | OK | OK | — | — | — | OK | OK |
| Stress level = 2000 psi, duration = 24 h | Cracked | — | Cracked | Cracked | — | — | — | OK | OK |
| Stress cracking resistance in diester oil | | | | | | | | | |
| Strain level = 1.5%, duration = 24 h | Cracked | OK | — | — | OK | — | — | — | — |
| Strain level = 1.5%, duration = 168 h | Cracked | OK | — | — | OK | — | — | — | — |
| Strain level = 1%, duration = 1000 h | Cracked | — | — | — | — | OK | OK | — | — |
| Thermal properties. Melting point (° C.) | None | — | 263 | None | — | — | — | 261 | 259 |
| Heat of fusion (J/g) | 0 | — | 1.1 | 0 | — | — | — | 8.6 | 2.7 |

### Preparation of Specimens of the Polymer Compositions.

All polymer compositions were prepared in the same way. The ingredients were pre-blended and dried in a desiccated circulating oven at 150° C. for 16 hours prior to compounding, notably to prevent hydrolytic degradation of the poly(ethylene naphthalate) ingredient. The so-obtained pre-blends were extruded on a Berstorff 25 mm co-rotating intermeshing twin screw extruder, with a die, a screw and 8 barrels, under the conditions listed in table 2 hereafter.

TABLE 2
Extruding conditions

| Temperature of barrel 1 (=throat) (° C.) | no heating |
|---|---|
| Temperature of barrel 2 (° C.) | 300 |
| Temperature of barrel 3 (° C.) | 310 |
| Temperature of barrel 4 (° C.) | 310 |
| Temperature of barrel 5 (° C.) | 310 |
| Temperature of barrel 6 (° C.) | 300 |
| Temperature of barrel 7 (° C.) | 300 |
| Temperature of barrel 8 (° C.) | 300 |
| Temperature of the die (° C.) | 310 |
| Temperature of the melt (° C.) | 336-347 |
| Vacuum level at barrel 7 (in Hg) | 25 |
| Screw speed (rpm) | 160 |
| Throughput rate (lb/hr) | 20 |

The extrudates were pelletized, and the so-obtained pellets were dried again and injection molded on a 50 ton Sumitomo injection molding machine, using the conditions of table 3, so as to obtain notably 3.2 mm ASTM Type I tensile and flexural specimens, and Izod impact bars.

TABLE 3
Injection molding conditions

| | |
|---|---|
| Rear barrel zone temperature (° F.) | 575 |
| Mid barrel zone temperature (° F.) | 585 |
| Front barrel zone temp. (° F.) | 605 |
| Nozzle temperature (° F.) | 665 |
| Mold temperature (° F.) | 300 |
| Injection pressure (psi) | 1460 |
| Holding pressure (psi) | 150 |
| Screw speed (rpm) | 40 |
| Cooling Time (s) | 18 |
| Cycle Time (s) | 35 |

### Testing of the Specimens.

### Evaluation of the Mechanical Properties of the Specimens.

Tensile strength, tensile modulus, yield elongation and tensile elongation at break were measured on tensile specimens according to ASTM method D-638.

Flexural strength and flexural modulus were measured on flexural specimens according to ASTM D-790.

Notched Izod was measured on Izod impact bars per ASTM D-256.

Heat deflection temperature was measured under a load of 264 psi according to ASTM D-648.

Weld line tensile properties were measured also according to ASTM D-638.

### Environmental Stress Cracking Resistance (ESCR) Evaluations

Flexural specimens were annealed at 200° C. for 1 h prior to any ESCR evaluations in order to remove any residual stresses introduced by the injection molding process. ESCR tests were conducted by mounting said annealed flexural specimens with rubber hose clamps onto fixed radius stain jigs that generate different levels of strain and nominal stress.

Exposure to methylethylketone (MEK) and toluene was performed by immersion for 24 h under various stress levels including 1000, 1500 and 2000 psi. The specimens were checked for failure after 30 min from the start of the test; they were checked again at the end of 24 h. For the specimens made of the invented compositions, the results after 24 h were identical to those after 30 minutes. Specimens qualified as “OK” exhibited no visible change after immersion.

Exposure to diester oil was performed by immersion for 168 h and 1000 h under various strain levels including 1.0 and 1.5%.

### Thermal Properties

The melting point temperature and the heat of fusion of the blends were assessed by conventional DSC technique, during second heat scan.

### Results

The results are presented in table 1.

In a surprising way, many of the mechanical properties of E3 and E8 poly(biphenyl ether sulfone)-poly(ethylene naphthalate) blends (according to the invention) were measured at a very high level, equal to or even sometimes improved with regard to poly(biphenyl ether sulfone) taken alone (CE1). See in particular their respective tensile strength, tensile modulus, flexural strength and flexural modulus. Also, surprisingly, the heat deflection temperature was only depressed by about 10° C., i.e. a modest drop for E3 and E8 blends relative to CE1.

While the tensile elongation at break, the notched Izod and the weld line properties were decreased more substantially, these could however be maintained at a satisfactory level for most of the encompassed end uses, in particular for bearings, i.e. typically a level of respectively:
well above 10%, as concerns the tensile elongation at break,
well above 1.0 ft.lb/in, as concerns the Notched Izod,
well above 4000 psi, as concerns the weld line tensile strength, and
well above 1.0% as concerns the weld line elongation at break, by maintaining the poly(ethylene naphthalate) over poly(biphenyl ether sulfone) weight ratio (P*)/(P) below the specified upper limit.

Thus, while achieving globally a good level of mechanical properties, the invented blends exhibit surprisingly an outstanding environmental stress cracking resistance, when immersed in a wide range of solvents including methylethylketone and toluene. In diester oil, a solvent of particular interest for making fluid dynamic bearings, the Applicant observed unexpectedly no visible failure for a specimen comprising poly(ethylene naphthalate) (P*) and poly(biphenyl ether sulfone) (P) in a weight ratio (P*)/(P) of 0.33, even after 1000 h exposure under a strain level of 1%. Also, a specimen made from blend E2 with a (P*)/(P) weight ratio as low as 0.14 [i.e. with only 12.5 wt. % of poly(ethylene naphthalate)] passed successfully a one-week ESCR test in diester oil under a strain level of 1.5%. On the other hand, poly(biphenyl ether sulfone) specimen (CE1) failed miserably: cracks were already observed after 1 day under the same strain level.

Besides, it was also surprisingly observed that the further incorporation of poly(ether imide) resulted in an important improvement of elongation at break, and, to a less extent, of the tensile strength, of the tensile modulus and of the flexural strength, as can be seen by comparing the results for blends E9 [with 5 wt. % of poly(ether imide)] and E8 [free of poly(ether imide)] on one hand. Further, it was agreeably observed that the further incorporation of poly(ether imide) had usually no detrimental effect on the other mechanical properties of the blends, in particular the notched Izod and the heat deflection temperature. Nor does it affect their environmental stress cracking resistance. Finally, it was surprisingly observed that poly(ether imide) made it possible to reduce importantly the crystallinity level of the blends, which level aimed at increasing with the amount of poly(ethylene naphthalate), as can be shown by comparing DSC results for E8 and E9 on one hand, and E2 and E3 on the other hand.

All references, including patent applications and patents, tests and standards, etc. mentioned herein are incorporated herein by reference, as are all brochures and technical data regarding products mentioned herein. Where a numerical limit or range is stated, all values and subranges therewithin are specifically included as if explicitly written out. The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A polymer composition (C) containing
a poly(aryl ether sulfone) material (P), composed of
at least one poly(aryl ether sulfone) (P1) with a multiple benzenic ring structure, or
at least one poly(aryl ether sulfone) (P1) with a multiple benzenic ring structure and at least one poly(aryl ether sulfone) (P2) different from the poly(aryl ether sulfone) (P1), and
a semi-aromatic polyester material (P1*), composed of
at least one semi-aromatic polyester (P1*) with a multiple benzenic ring structure, or
at least one semi-aromatic polyester (P1*) with a multiple benzenic ring structure and at least one semi-aromatic polyester (P2*) different from the semi-aromatic polyester (P1*),
wherein the semi-aromatic polyester material (P*) over poly(aryl ether sulfone) material (P) weight ratio [(P*)/(P) weight ratio] is between 0.13 and 1.00.

2. The polymer composition according to claim 1, wherein the (P*)/(P) weight ratio is between 0.20 and 0.70.

3. The polymer composition according to claim 2, wherein the (P*)/(P) weight ratio is between 0.30 and 0.50.

4. (canceled)

5. (canceled)

6. (canceled)

7. The polymer composition according to claim 1, wherein the poly(aryl ether sulfone) material (P) is contained in the polymer composition (C) in an amount of more than 40 wt. % based on the total weight of the polymer composition (C).

8. (canceled)

9. The polymer composition according to claim 1, wherein more than 50 mol. % of the recurring unites of poly(aryl ether sulfone) (P1) are recurring units (R1) of formula are:

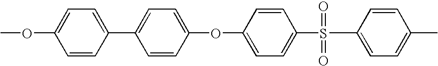

10. The polymer composition according to claim 1, wherein the poly(aryl ether sulfone) (P1) is a homopolymer.

11. The polymer composition according to claim 1, wherein the poly(aryl ether sulfone) material (P) is composed of the poly(aryl ether sulfone) (P1).

12. The polymer composition according to claim 1, wherein the poly(aryl ether sulfone) material (P) is composed of the poly(aryl ether sulfone) (P1) and the poly(aryl ether sulfone) (P2), the weight of the poly(aryl ether sulfone) (P2) ranging from ⅓ to ⅔ of the weight of the poly(aryl ether sulfone) material (P).

13. The polymer composition according to claim 1, wherein the semi-aromatic polyester material (P*) is contained in the polymer composition (C) in an amount of between 12 and 35 wt. %, based on the total weight of the polymer composition (C).

14. (canceled)

15. (canceled)

16. The polymer composition according to claim 1, wherein more than 50 mol. % of the recurring units of the semi-aromatic polyester (P1*) are recurring units (R1*) of formula: 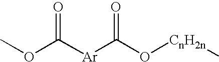
wherein CₙH₂ₙ is a C₂-C₈ alkylene group and Ar is a naphthylene group.

17. The polymer composition according to claim 10, wherein the recurring units (R1*) are:

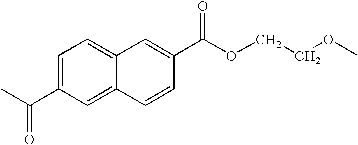

18. The polymer composition according to claim 1, wherein the semi-aromatic polyester (P1*) is a homopolymer.

19. The polymer composition according to claim 1, wherein the semi-aromatic polyester material (P*) is composed of the semi-aromatic polyester (P1*).

20. (canceled)

21. The polymer composition according to claim 1, which further comprises a metal or a metal alloy in particulate form.

22. (canceled)

23. The polymer composition according to claim 1, which further comprises graphite fiber.

24. The polymer composition according to claim 1, which further comprises at least one poly(ether imide).

25. (canceled)

26. (canceled)

27. (canceled)

28. (canceled)

29. (canceled)

30. (canceled)

31. (canceled)

32. (canceled)

33. (canceled)

34. (canceled)

35. A polymer composition (C) containing
more than 40 wt. %, based on the total weight of the polymer composition (C), of a poly(aryl ether sulfone) material (P) composed of a poly(aryl ether sulfone) homopolymer (P1) the recurring units of which are recurring units (R1) of formula 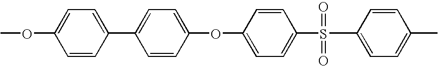
and
more than 12 wt. %, based on the total weight of the polymer composition (C), of a semi-aromatic polyester material (P*) composed of a semi-aromatic polyester homopolymer (P1*) the recurring units of which are recurring units (R1*) of formula 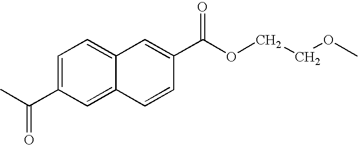
wherein the semi-aromatic polyester material (P*) over poly(aryl ether sulfone) material (P) weight ratio [(P*)/(P) weight ratio] is between 0.20 and 0.70.

36. A method for improving the environmental stress cracking resistance of a poly(aryl ether sulfone) material (P) in the need thereof, said poly(aryl ether sulfone) material (P) being composed of
at least one poly(aryl ether sulfone) (P1) with a multiple benzenic ring structure, or
at least one poly(aryl ether sulfone) (P1) with a multiple benzenic ring structure and at least one poly(aryl ether sulfone) (P2) different from poly(aryl ether sulfone) (P1),
said method comprising blending the poly(aryl ether sulfone) material (P) with a semi-aromatic polyester material (P*) composed of
at least one semi-aromatic polyester (P1*) with a multiple benzenic ring structure, or
at least one semi-aromatic polyester (P1*) with a multiple benzenic ring structure and at least one semi-aromatic polyester (P2*) different from semi-aromatic polyester (P1*),
so as to form a polymer composition (C) containing the poly(aryl ether sulfone) material (P) and the semi-aromatic polyester material (P*), wherein the semi-aromatic polyester material (P*) over poly(aryl ether sulfone) material (P) weight ratio [(P*)/(P)] is between 0.13 and 1.00.

37. The method according to claim 36 wherein the poly(aryl ether sulfone) material (P) is a poly(aryl ether sulfone) homopolymer (P1) of recurring units (R1) 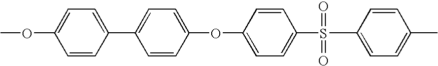
the semi-aromatic polyester material (P*) is a semi-aromatic polyester homopolymer (P1*) of recurring units (R1*) 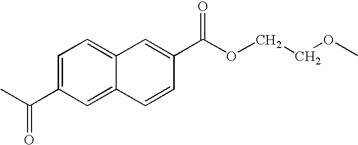
and (P*)/(P) is between 0.30 and 0.50.

38. The method according to claim 37, wherein the environmental stress cracking resistance is improved in an environment selected from the group consisting of aromatic compounds, ketones, chlorinated hydrocarbons and esters.
